(19) United States
(12) Patent Application Publication
(10) Pub. No.: US 2020/0211034 A1
(43) Pub. Date: Jul. 2, 2020

(54) AUTOMATICALLY ESTABLISHING TARGETING CRITERIA BASED ON SEED ENTITIES

(71) Applicant: Microsoft Technology Licensing, LLC, Redmond, WA (US)

(72) Inventors: Luke Kopakowski, San Francisco, CA (US); Nitin Julka, Alameda, CA (US); Bita Gorjiara, Sunnyvale, CA (US); Eva Chau, Sunnyvale, CA (US); Jae Oh, San Mateo, CA (US)

(21) Appl. No.: 16/233,047

(22) Filed: Dec. 26, 2018

(51) Int. Cl. G06Q 30/02

(52) U.S. Cl. CPC G06Q 30/0201; G06Q 30/0269; G06Q 30/0242

(57) ABSTRACT

Technologies for identifying and recommending dimension values for a content delivery campaign are provided. Disclosed techniques include receiving, from a content provider, input that selects one or more entities. In response to receiving the input, a plurality of dimension values are identified from each of the one or more entities. Dimension values may represent attributes associated with entities. A set of dimension values for recommendation may be identified from the plurality of dimension values previously identified. The set of dimension values for recommendation may be presented to the content provider for the purpose of generating a content delivery campaign based upon the recommended set of dimension values.

### TECHNICAL FIELD

The present disclosure relates to identifying targeting criteria for a content delivery campaign based upon analyzing attributes of provided users, and more specifically, to computer software that analyzes provided user attribute values and determines a set of relevant attribute values that may be used to generate a content delivery campaign.

### BACKGROUND

Content delivery systems are configured to deliver relevant content to users by determining a set of users that may be interested in the content to be delivered. The content delivery systems may target their content to users that have shown interest in the content or subject matter related to the content. For example, if the content delivery system intends to deliver content related to software engineers in the San Francisco Bay Area, then the content delivery system may target a set of users that have matching attribute values, such as an occupation equal to software engineer and a current residence within the San Francisco Bay Area. However, many content delivery campaigns may contain targeting criteria that is more complex than occupation and current residence location.

Conventional content delivery systems may provide administrators of content delivery campaigns with options to select several different attribute types and attribute values for selected attribute types in order to create targeting criteria for a content delivery campaign. For example, conventional systems may present a user interface that displays several different attribute types, several sub-attribute types, and values for each attribute and/or sub-attribute type. However, administrators may become overwhelmed by the number of attribute and sub-attribute options presented and may not be able to accurately select correct attribute values based upon the number of options presented.

Additionally, administrators of content delivery campaigns may not be sure which attributes provide the most efficient targeting criteria for a target audience. In many cases, content delivery campaign administrators may have one or a set of users that they would like to target but, do not exactly know which attributes of these users they should target. As a result, conventional content delivery systems are not effective in providing and recommending relevant attribute values targeted to the intended audience.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment.

FIG. 2 depicts a block diagram of an example software-based system for identifying and recommending a set of dimension values as properties for a content delivery campaign, in an embodiment.

FIG. 3 depicts an example flowchart for generating and presenting dimension value recommendations based upon model entities for a new content delivery campaign, in an embodiment.

FIG. 4A depicts an example of representative entities and their associated dimensions and dimension values, in an embodiment.

FIG. 4B depicts an example of representative entities and their associated dimensions and dimension values with assigned score values, in an embodiment.

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

As disclosed herein, identifying and recommending attribute values for a content delivery campaign is improved by adding technology that implements a particular approach of analyzing attribute values from potential target users and determining a set of attribute values to recommend based on attribute values from the potential target users. One particular approach may receive, from a content provider, input that selects one or more entities. In response to receiving input, for each entity, a plurality of dimension values may be identified, where a dimension value herein refers to an attribute value. A set of dimension values may be determined for recommendation to the content provider based on the plurality of dimension values identified from the one or more entities. The set of dimension values may be presented to the content provider as a recommendation of dimension values to be used to generate a content delivery campaign.

The disclosed approaches provide advantages over conventional solutions by providing a recommended set of dimension values for generating a content delivery campaign. Conventional solutions provide content providers with a large set of available dimension values, which may cause confusion and several iterations of trial and error when trying to determine a desired set of dimension values for a content delivery campaign. The disclosed approaches provide greater efficiency in determining the desired set of dimension values based upon potential target users provided by the content provider. These disclosed approaches may reduce processing resources consumed by presenting the entire set of dimension values to the content provider without filtering dimension values to represent one or more potential target users.

### System Overview

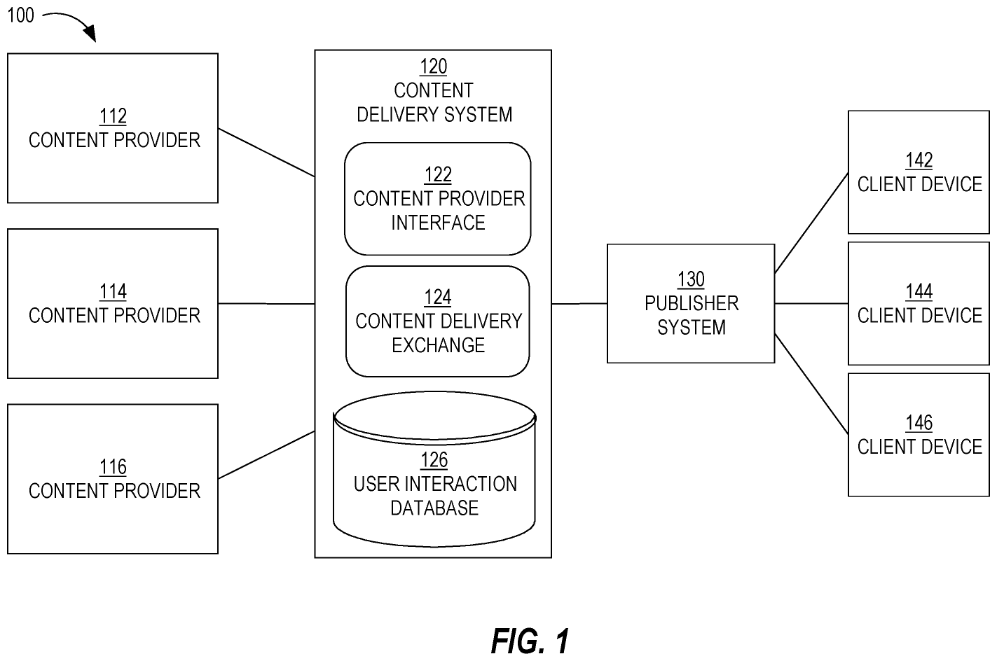

FIG. 1 is a block diagram that depicts a system 100 for distributing content items to one or more end-users, in an embodiment. System 100 includes content providers 112-116, a content delivery system 120, a publisher system 130, and client devices 142-146. Although three content providers are depicted, system 100 may include more or less content providers. Similarly, system 100 may include more than one publisher and more or less client devices.

Content providers 112-116 interact with content delivery system 120 (e.g., over a network, such as a LAN, WAN, or the Internet) to enable content items to be presented, through publisher system 130, to end-users operating client devices 142-146. Thus, content providers 112-116 provide content items to content delivery system 120, which in turn selects content items to provide to publisher system 130 for presentation to users of client devices 142-146. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery campaigns and (2) a content delivery exchange 124 that conducts content item selection events in response to content requests from a third-party content delivery exchange and/or from publisher systems, such as publisher system 130.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 124, and that bids for space (on one or more publisher systems, such as publisher system 130) to present content items on behalf of multiple content providers. Thus, a bidder is another source of content items that content delivery exchange 124 may select for presentation through publisher system 130. Thus, a bidder acts as a content provider to content delivery exchange 124 or publisher system 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery system 120 through, for example, content provider interface 122. An example of content provider interface 122 is Campaign Manager' provided by LinkedIn. Content provider interface 122 comprises a set of user interfaces that allow a representative of a content provider to create an account for the content provider, create one or more content delivery campaigns within the account, and establish one or more attributes of each content delivery campaign. Examples of campaign attributes are described in detail below.

A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select, or click on the set of content items, when a certain number of users purchase a product/service associated with the content delivery campaign or fill out a particular form on a website, or when a budget of the content delivery campaign has been exhausted.

A content delivery campaign may specify one or more targeting criteria that are used to determine whether to present a content item of the content delivery campaign to one or more users. (In most content delivery systems, targeting criteria cannot be so granular as to target individual members.) Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery campaign are not sent to the computing device.

Thus, content delivery exchange 124 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 124 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher system 130 may not satisfy targeting criteria of one content item of a campaign, the same content request may satisfy targeting criteria of another content item of the campaign.

Different content delivery campaigns that content delivery system 120 manages may have different charge models. For example, content delivery system 120 (or, rather, the entity that operates content delivery system 120) may charge a content provider of one content delivery campaign for each presentation of a content item from the content delivery campaign (referred to herein as cost per impression or CPM). Content delivery system 120 may charge a content provider of another content delivery campaign for each time a user interacts with a content item from the content delivery campaign, such as selecting or clicking on the content item (referred to herein as cost per click or CPC). Content delivery system 120 may charge a content provider of another content delivery campaign for each time a user performs a particular action, such as purchasing a product or service, downloading a software application, or filling out a form (referred to herein as cost per action or CPA). Content delivery system 120 may manage only campaigns that are of the same type of charging model or may manage campaigns that are of any combination of the three types of charging models.

A content delivery campaign may be associated with a resource budget that indicates how much the corresponding content provider is willing to be charged by content delivery system 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

### Content Item Selection Events

As mentioned previously, a content item selection event is when multiple content items (e.g., from different content delivery campaigns) are considered and a subset selected for presentation on a computing device in response to a request. Thus, each content request that content delivery exchange 124 receives triggers a content item selection event.

For example, in response to receiving a content request, content delivery exchange 124 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 124 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery system 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 124 conducts one or more content item selection events. Thus, content delivery exchange 124 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that operates content delivery system 120 conducts one or more content item selection events. In this latter embodiment, content delivery system 120 sends one or more content items to the other exchange, which selects one or more content items from among multiple content items that the other exchange receives from multiple sources. In this embodiment, content delivery exchange 124 does not necessarily know (a) which content item was selected if the selected content item was from a different source than content delivery system 120 or (b) the bid prices of each content item that was part of the content item selection event. Thus, the other exchange may provide, to content delivery system 120, information regarding one or more bid prices and, optionally, other information associated with the content item(s) that was/were selected during a content item selection event, information such as the minimum winning bid or the highest bid of the content item that was not selected during the content item selection event.

### Event Logging

Content delivery system 120 may log one or more types of events, with respect to content item summaries, across client devices 142-146 (and other client devices not depicted). For example, content delivery system 120 determines whether a content item summary that content delivery exchange 124 delivers is presented at (e.g., displayed by or played back at) a client device. Such an “event” is referred to as an “impression.” As another example, content delivery system 120 determines whether a content item summary that exchange 124 delivers is selected by a user of a client device. Such a “user interaction” is referred to as a “click.” Content delivery system 120 stores such data as user interaction data, such as an impression data set and/or a click data set. Thus, content delivery system 120 may include a user interaction database 128. Logging such events allows content delivery system 120 to track how well different content items and/or campaigns perform.

For example, content delivery system 120 receives impression data items, each of which is associated with a different instance of an impression and a particular content item summary. An impression data item may indicate a particular content item, a date of the impression, a time of the impression, a particular publisher or source (e.g., onsite v. offsite), a particular client device that displayed the specific content item (e.g., through a client device identifier), and/or a user identifier of a user that operates the particular client device. Thus, if content delivery system 120 manages delivery of multiple content items, then different impression data items may be associated with different content items. One or more of these individual data items may be encrypted to protect privacy of the end-user.

Similarly, a click data item may indicate a particular content item summary, a date of the user selection, a time of the user selection, a particular publisher or source (e.g., onsite v. offsite), a particular client device that displayed the specific content item, and/or a user identifier of a user that operates the particular client device. If impression data items are generated and processed properly, a click data item should be associated with an impression data item that corresponds to the click data item. From click data items and impression data items associated with a content item summary, content delivery system 120 may calculate a CTR for the content item summary.

### Dimension Value Recommendation Service

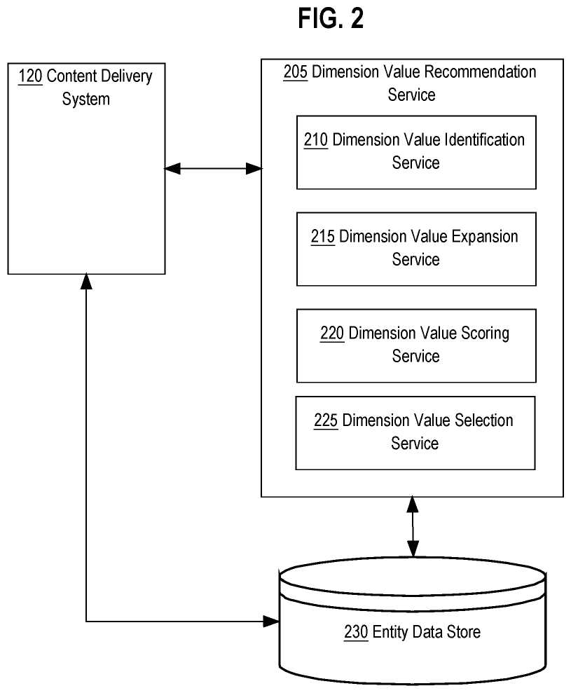

FIG. 2 depicts a block diagram of an example software-based system for identifying and recommending a set of dimension values as properties for a content delivery campaign. An entity may refer to a user, a user's profile, a company, a company's profile, or any other object that may represent a person, a group, a place, or thing. For the purposes of this disclosure the terms entity, user, user profile, company, or company profile may be used interchangeably. In an embodiment, the dimension value recommendation service 205 may be configured to access entities from an entity data store 230 in order to retrieve dimensions and dimension values associated with specific entities. A dimension may refer to a category or an attribute type associated with an entity that may be selected for targeting by a content delivery campaign. Examples of dimensions may include, but are not limited to, job title, job function, skills, residence location, professional interests, personal interests, employer, company size, industry, and any other attribute type that may describe an entity. Dimension values may refer to specific attribute values for a category or attribute type. For instance, if an entity, such as a user profile, specifies that the user has a job title of “principal software engineer,” then the dimension value would be the title principal software engineer for the dimension job title.

In an embodiment, the content delivery system 120 may utilize the dimension value recommendation service 205 for the purpose of identifying and recommending dimension values for a content delivery campaign that targets the intended audience. For example, a content provider, when generating a new content delivery campaign, may specify one or more model entities, such as potential target users, that are to be used as example targets for the new content delivery campaign. The content delivery system 120 may be communicatively coupled to the dimension value recommendation service 205. The content delivery system 120 may send a request with the one or more model entities to the dimension value recommendation service 205 for the purpose to determining a set of recommended dimension values for the new content delivery campaign. The one or more model entities within the request may represent different types of entities, such as a person, company, group or organization, products, or services.

In an embodiment, the dimension value recommendation service 205 may include a dimension value identification service 210, a dimension value expansion service 215, a dimension value scoring service 220, and a dimension value selection service 225. The dimension value identification service 210 may be configured to identify, for each received entity, a set of one or more dimension values associated with each respective entity. For example, a received entity may be user “Jane Smith” who, based on her user profile, is a principal software engineer that currently works at Google, lives in San Francisco, and has interests that include field-programmable gate array (FPGA) and databases. The dimension value identification service 210 may identify the dimensions of job title, company, city of residence, and interests and the corresponding dimension values as principal software engineer, Google, San Francisco, FPGA, and databases.

In an embodiment, the dimension value identification service 210 may be configured to determine whether any of the identified dimension values are entities themselves. Using the current example of Jane Smith, the identified dimension value of Google may also be an entity that represents the company Google. The dimension value recommendation service 205 may then expand the set of identified dimension values by identifying dimension values associated with the entity Google. For example, the dimension value identification service 210 may identify the dimensions industry type and company size and corresponding dimension values “technology” and “above 100,000 employees.” These additional dimension values may be associated with the entity Jane Smith as additional dimension values.

In an embodiment, the dimension value expansion service 215 may be configured to identify one or more dimension values that are similar to previously identified dimension values. For example, the dimension value expansion service 215 may receive as input the dimension value Google, which is associated with entity Jane Smith. The dimension value expansion service 215 may then retrieve other dimension values that are similar to Google, such as other large companies in the technology industry. Identifying similar dimension values is not limited to determining similar companies. For example, the dimension value expansion service 215 may receive as input the dimension value “principal software engineer” for dimension job title. The dimension value expansion service 215 may then determine other job titles that are similar to “principal software engineer” such as senior software engineer, lead software engineer, or software architect.

In an embodiment, the dimension value scoring service 220 may be configured to calculate and assign a recommendation score to each of the identified dimension values. The recommendation score may be based on one or more factors including, but not limited to, the number of model entities that have the associated dimension value, historical relevance of the dimension value with respect to content delivery campaigns, the number of entities within the entity data store 230 that are associated with the dimension value, frequency the dimension value is included in prior content delivery campaigns for the content provider, frequency the dimension value is included in other content delivery campaigns by other content providers, and other configurable coefficients determined using linear or logistic regression techniques.

In an embodiment, the dimension value selection service 225 may be configured to select the set of dimension values to recommend and present to the content provider as the set of preferred dimension values for generating a content delivery campaign that is based upon the provided model entities. The dimension value selection service 225 may be configured to evaluate each of the identified dimension values based upon their assigned recommendation score. Each of the selected dimension values in the set of dimension values may have a score that is greater than a defined minimum score, where the minimum score may be based upon historical content delivery campaign performance. Additionally, the dimension value selection service 225 may be configured to limit the total number of dimension values based upon historical content delivery campaign performance. The configured limitation for dimension values may limit the total number of dimension values selected in the set of dimension values or may limit the number of dimension values for each unique dimension. For example, the dimension job title may be limited to include only 5 different dimension values for job title. In other examples, the limit may be higher or lower and may be configurable based on historical performance of content delivery campaigns and/or content provider preferences.

In an embodiment, the entity data store 230 may represent data storage configured to store entities, such as user and company profiles, dimensions, and dimension values for a plurality of entities. For example, the entity data store 230 may store user profiles for users and companies, including their associated profile attribute values.

### Generating Dimension Value Recommendations

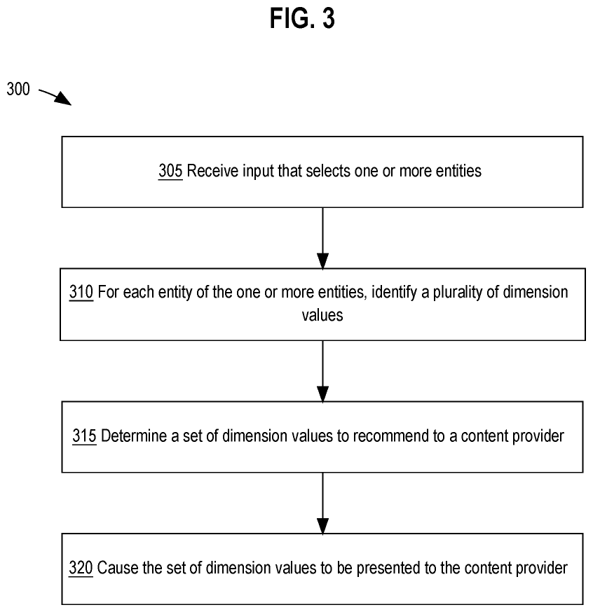

FIG. 3 depicts an example flowchart for generating and presenting dimension value recommendations based upon one or more entities provided as model entities for a new content delivery campaign. Process 300 may be performed by a single program or multiple programs. The operations of the process as shown in FIG. 3 may be implemented using processor-executable instructions that are stored in computer memory. For purposes of providing a clear example, the operations of FIG. 3 are described as performed by the dimension value recommendation service 205 and the content delivery system 120. For the purposes of clarity process 300 is described in terms of a single entity. In an embodiment, the dimension value recommendation service 205 may perform the operations of process 300 on a set of entities that may be stored within the entity data store 230.

In operation 305, process 300 receives input that selects one or more entities. In an embodiment, the dimension value identification service 210 may receive input specifying a selection of one or more entities that may be representative of a target audience for a new content delivery campaign. For example, the dimension value identification service 210 may receive input specifying entities for “Jane Smith,” “John Hernandez,” and the company “Apple.” These model entities may be representative of the audience to be targeted by the new content delivery campaign. For instance, both Jane Smith and John Hernandez may be software engineers and the company Apple may employ software engineers, which may be the primary target audience of the new content delivery campaign. The received model entities may include different types of entities, such as people, companies, products, and services that may stored as an entity object within the entity data store 230.

### Identifying Dimension Values From Input Entities

In operation 310, process 300 identifies a plurality of dimension values for each entity received. In an embodiment, the dimension value identification service 210 may retrieve dimensions and dimension values associated with each of the entities received at operation 305. For example, the dimension value identification service 210 may access the entity data store 230 to retrieve information associated with each of the entities, including retrieving associated dimensions and dimension values.

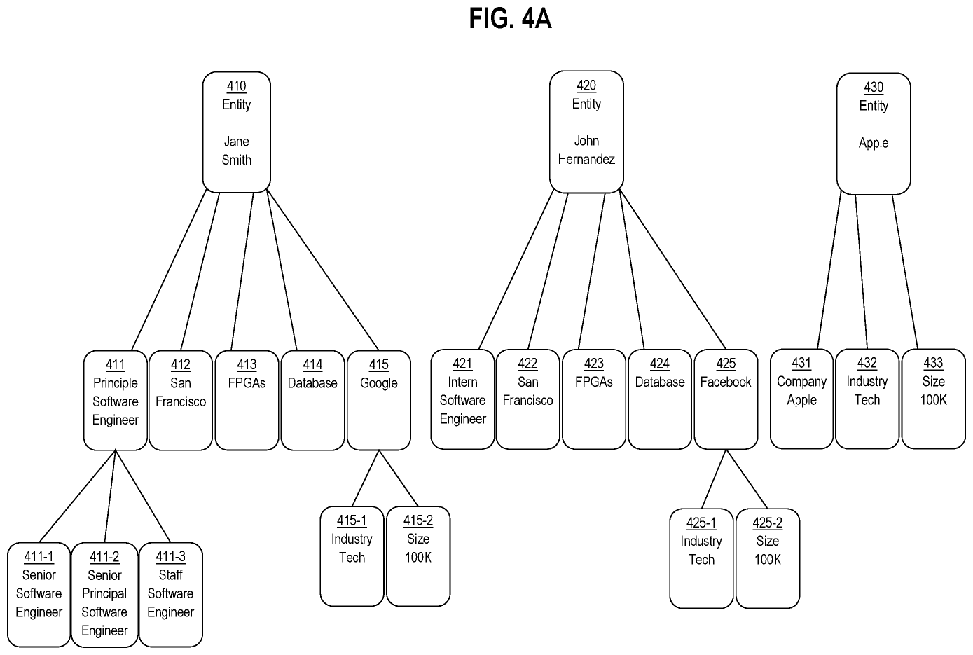

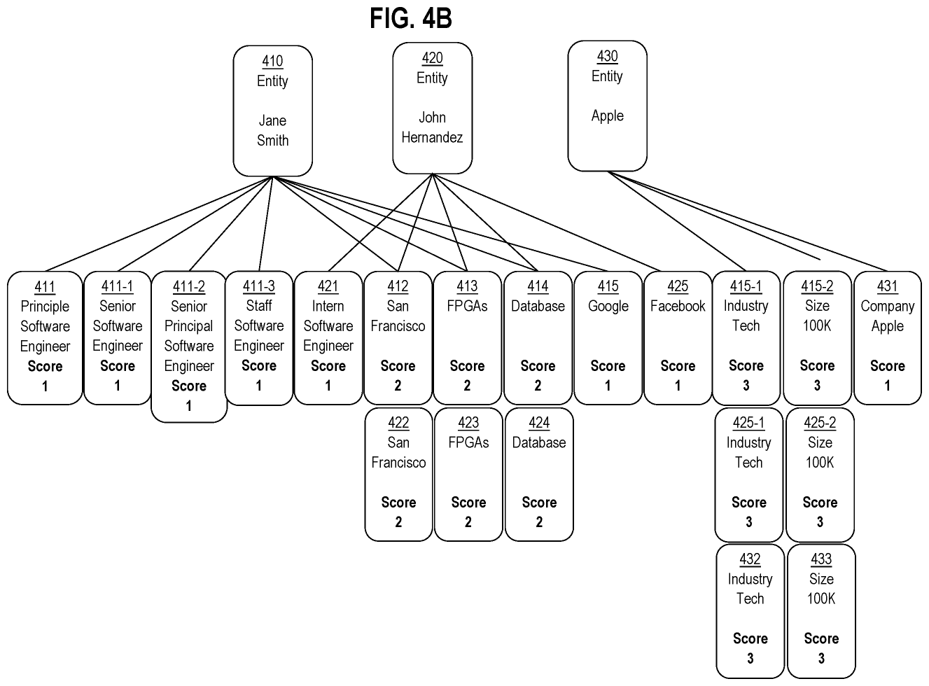

FIG. 4A depicts an example of representative entities and their associated dimensions and dimension values. Node 410 represents the entity Jane Smith and nodes 411-415 each represent a dimension and dimension value associated with the entity Jane Smith. The dimension value identification service 210 may access the node 410 entity from the entity data store 230, which may include accessing the user profile for Jane Smith. The dimension value identification service 210 may then identify one or more attributes from the user profile corresponding to Jane Smith. The identified dimensions and dimension values are represented by nodes 411-415. Node 411 represents dimension “job title” with a dimension value of “principal software engineer.” Node 412 represents dimension “residence location” with a dimension value of “San Francisco.”Node 413 represents dimension “interest” with a dimension value of “FPGAs.” Node 414 represents dimension “interest” with a dimension value of “databases.” Node 415 represents dimension “company” with a dimension value of “Google.”

In an embodiment, the dimension value identification service 210 may access the profile for the entity corresponding to “John Hernandez” and may retrieve associated dimensions and dimension values from the user profile corresponding to entity John Hernandez. Referring to FIG. 4A, node 420 represents the entity John Hernandez and nodes 421-425 represent dimension and dimension values for attributes of the entity John Hernandez. Node 421 represents dimension “job title” with a dimension value of “intern software engineer.” Node 422 represents dimension “residence location” with a dimension value of “San Francisco.” Node 423 represents dimension “interest” with a dimension value of “FPGAs.” Node 424 represents dimension “interest” with a dimension value of “databases.” Node 425 represents dimension “company” with a dimension value of “Facebook.”

In an embodiment, the dimension value identification service 210 may access the profile for the entity corresponding to the company “Apple” and may retrieve associated dimensions and dimension values from the company profile corresponding to entity Apple. Referring to FIG. 4A, node 430 represents the entity Apple and nodes 431-433 represent dimension and dimension values for attributes of the entity Apple. Node 431 represents dimension “company” with a dimension value of “Apple.” Node 432 represents dimension “industry” with a dimension value of “technology.” Node 433 represents dimension “size” with a dimension value of “100,000.” In yet other embodiments not pictured, the dimension value identification service 210 may access entities that may correspond to other subject matter, such as products, where the dimensions may refer to attributes that describe the product, such as wearable product, brand, consumer demographic, and so on.

The dimension values associated with entities may also be entities themselves. For example, node 415 represents the dimension company and the dimension value Google. The dimension value Google may also be an entity stored within the entity data store 230. In an embodiment, the dimension value identification service 210 may determine whether any of the identified dimension values are also entities by accessing the entity data store 230 to determine whether any dimension values are also entities. For instance, the dimension value identification service 210 may determine that dimension values for node 415 (Google) and 425 (Facebook) also represent entities corresponding to companies. The dimension value identification service 210 may then access each of the additional entities to determine dimensions and dimension values that may be useful as a recommendation for the new content delivery campaign. Nodes 415-1, 415-2, 425-1, and 425-2 each represent dimension and dimension values of entities corresponding to Google and Facebook. Node 415-1 represents dimension “industry” with a dimension value of “technology.” Node 415-2 represents dimension “size” with a dimension value of “100,000.” Node 425-1 represents dimension “industry” with a dimension value of “technology.” Node 425-2 represents dimension “size” with a dimension value of “100,000.” The dimension value identification service 210 may then associate nodes 415-1 and 415-2 to node 410 representing entity Jane Smith since nodes 415-1 and 415-2 originated from node 415 which is associated with node 410. In an embodiment, nodes that have been identified from an existing dimension value that is also entity may be tagged as an additional or second-level dimension value since it was not originally identified from attributes of the original entity. For instance, nodes 425-1 and 425-2 may be associated as second-level dimension values to node 420.

In an embodiment, the dimension value identification service 210 may be configured to iteratively determine whether newly identified dimension values are also entities within the entity data store 230. For example, newly identified dimension values (nodes 415-1, 415-2, 425-1, and 425-2) may be checked against the entity data store 230 to see if any of the new dimension values are also entities. If at least one dimension value is also an entity, then the dimension value identification service 210 may identify additional dimension values and tag the additional dimension values as having an extra level of association, such as a third-level or fourth level association and so on. The association level of dimension values with respect to the model entities may be scored and used when determining a recommended set of dimension values. For instance, dimension values that have a higher level (further away from the originating entity) may have a lower score and thus may be considered less valuable to determining the set of recommended dimension values for the new content delivery campaign.

### Dimension Value Expansion

In another embodiment, dimension values that are similar to the identified dimension values may also be discovered and recommended. Similar dimension values may refer to attribute values that are of the same dimension and are closely related to already identified dimension values. For example, job titles that are similar to “principal software engineer” or “intern software engineer” may be identified and associated with the model entities and may be useful dimension values to recommend for the new content delivery campaign. In an embodiment, the dimension value identification service 210 may send the identified set of dimension values identified from the model entities to the dimension value expansion service 215 to determine additional dimension values that are similar to the identified set of dimension values.

In an embodiment, the dimension value expansion service 215 may access previously created content delivery campaigns by either the same content provider or other content providers to determine whether there are any common dimension values between the identified set of dimension values and dimension values associated with the previously created content delivery campaigns. If there are common dimension values, then dimension value expansion service 215 may determine whether there are any additional dimension values that are associated with the same dimension as the common dimension values. For example, if the dimension value expansion service 215 determines that previously created content delivery campaigns also contain the dimension/dimension value of company/Google, then the dimension value expansion service 215 may determine if other company dimension values are associated with the previously created content delivery campaigns. If the dimension value expansion service 215 determines that dimension values, such as Cisco, Oracle, and LinkedIn, are also associated with the previously created content delivery campaigns then the dimension value expansion service 215 may associated the dimension values of Cisco, Oracle, and LinkedIn to the set of identified dimension values as similar dimension values.

In an embodiment, the entity data store 230 may be configured to store dimension taxonomies of dimension values within hierarchical data structures. The data structures may include value trees containing a root node and levels of additional nodes that form a hierarchy. In one example, nodes of the data structure may represent dimension values of different job titles derived from attributes of user profiles. The root node of the data structure is the top level node and may represent a broadest job title that includes all other derived job titles. Child nodes that descend directly from the root node may each represent a distinct job title that is a subset of the root node. Subsequent child nodes may each represent a distinct subset of their parent node. For example, if a parent node represents the job title of “Engineer” then child nodes of the parent may include “Software Engineer,” “Hardware Engineer,” “Support Engineer,” “QA Engineer,” and so on. In other examples, dimension value taxonomies may represent different dimensions including, but not limited to, residence location, interests, company, industry, and many others.

In an embodiment, the dimension value expansion service 215 may determine similar dimension values by accessing the stored taxonomies in the entity data store 230. The dimension value expansion service 215 may locate a particular node representing a particular dimension value such as principal software engineer, which has been associated with entity Jane Smith. The dimension value expansion service 215 may then identify a parent node of the particular node. From the parent node, the dimension value expansion service 215 may identify sibling nodes that are child nodes of the parent node identified. The sibling nodes may have a close relationship to the particular node based upon their common parent node. For example, the parent node to the particular node (principal software engineer) may represent the dimension value “software engineer.” The parent node (software engineer) may then have other child nodes that are siblings to the particular node (principal software engineer). For instance, the sibling nodes may include “senior software engineer,” “staff software engineer,” and “senior principal engineer.” Referring to FIG. 4A, nodes 411-1, 411-2, and 411-3 may represent nodes identified by the dimension value expansion service 215 as similar dimension values to node 411. Node 411-1 may represent dimension value senior software engineer. Node 411-2 may represent dimension value senior principal software engineer. Node 411-3 may represent dimension value staff software engineer.

In yet another embodiment, the dimension value expansion service 215 may determine similar dimension values by determining dimension values that are closely related based upon relationships between dimension values of the same dimension. For example, if the dimension is job title and the dimension value is principal software engineer, then the dimension value expansion service 215 may search for other job title dimension values that are close in relation based upon job title hierarchies determined from industry standards and/or company specific hierarchies. For instance, senior software engineer may be determined as close in relation because a person who is a senior software engineer may be promoted or may be looking for a promotion to principal engineer. Other factors may be used to determine a close relationship such as current years of experience as a senior software engineer. If a user that is a senior software engineer has been a senior software engineer for 5 years, then there may be a higher probability that the user may seek a promotion to principal software engineer. Other examples are not limited to job title. The location dimension may be used where locations that are close in proximity to the identified location may be identified as similar dimension values.

### Determining a Set of Dimension Values for Recommendation

Referring to FIG. 3, at operation 315 process 300 may determine a set of dimension values to recommend to the content provider. In an embodiment, the dimension value recommendation service 205 may determine a set of dimension values, from the plurality of identified dimension values, for recommendation to the content provider based upon assigned dimension value scores to each of the identified dimension values. A dimension value score may represent a calculation of various observations of entities associated with a particular dimension value and/or observations of performance of content delivery campaigns that include the particular dimension value.

In an embodiment, the dimension value scoring service 220 may implement the following scoring algorithm to calculate dimension value scores:

Score=C₁*(Frⁿ*Dᵢ*A)+C₂*Ca+C₃*Ind+C₄*A_{c}−T

where:

Fr: equals frequency, which is the number of times a particular dimension value is associated with the provided model entities. For example, dimension value San Francisco is associated with entities Jane Smith and John Hernandez, which equates to the frequency Fr equaling two.

Di: equals a dimension multiplier. The dimension multiplier refers to a multiplier value that may be used to optimize the algorithm for dimension values that are either particularly useful or may want to be excluded/minimized. For example, if the dimension value is industry, then a high multiplier may be used because industry is likely to be deemed useful to a content delivery campaign. If, however, the dimension value is gender, then the multiplier may be a low value, such as 0, if the gender attribute is not relevant or should be excluded.

A: represents an audience size, which represents the number of entities, within the entire entity data store 230, that have the particular dimension value. If a particular dimension value is associated with a large number of entities, for instance there are 100,000 entities that have FPGAs as an interest attribute, then the particular dimension value of FPGAs may be scored higher based on the audience size.

Ca: equals the frequency that a particular dimension value occurs across previously created content delivery campaigns within the content delivery system 120.

Ind: equals the frequency that a particular dimension value occurs across previously created content delivery campaigns associated with a particular industry.

Ac: equals the frequency that a particular dimension value occurs across content delivery campaigns created by the particular content provider.

T: equals a minimum threshold value used to select dimension values that have a frequency above the minimum threshold.

Cn: equals configurable constant values for each of the factors within the scoring algorithm. Each of the constant values may be adjusted in order to increase or decrease the weight of each of the factors within the scoring algorithm.

Embodiments of the scoring algorithm are not limited to the above described algorithm. The scoring algorithm may include more or less observable factors and may calculate relationships between the observable factors in other ways as well. For example, the dimension value scoring service 220 may implement the scoring algorithm as:

Score=C₁*Fr+C₂+C₅*A+C₆*Ca+C₇*A_{c}−T

In an embodiment, configurable constant values of the scoring algorithms, such as Cn and T, may be tuned using performance metrics and feedback from one or more previously generated content delivery campaigns. For example, positive and negative feedback, based on conversions, click through rates, and other metrics, may be used to determine whether constant values that provide weight to various factors and the minimum threshold value are favorable or unfavorable to the success of a content delivery campaign. In an embodiment, the dimension value scoring service 220 may adjust constant values and the minimum threshold value of the scoring algorithm using machine learning algorithms, such as linear regression and logistic regression to determine which factors should be weighed more and which factors should be weighed less.

In another embodiment, the dimension value scoring service 220 may adjust constant values of the scoring algorithm based upon tracking which dimension values presented to a content provider during content delivery campaign creation are selected by the content provider and which dimension values presented are not selected. For example, if the dimension value recommendation service 205 presents a set of dimension values, which includes FPGAs and databases, to the content provider and the content provider only selects databases for the content delivery campaign, then the dimension value scoring service 220 may determine that the dimension value FPGAs is less likely to be selected during content delivery campaign creation and may reduce the weight of constant values or may reduce the dimension multiplier, Di, associated with the dimension value FPGAs. Additionally, the dimension value scoring service 220 may determine that the dimension value databases is more likely to be selected and may increase the weight of constant values or may increase the dimension multiplier, Di, associated with that particular dimension value.

In an embodiment, the dimension value scoring service 220 may adjust dimension value scores based upon how and when each dimension value was identified by the dimension value identification service 210. For example, if a particular dimension value was identified from attributes directly associated with a model entity, then the dimension value scoring service 220 may assign a higher weight. If, however, the particular dimension value was identified as an attribute of another identified dimension value that is also an entity, then less weight may be assigned to the particular dimension value. Referring to FIG. 4A, nodes 411-415 may be assigned a score adjustment value of 1. Nodes 415-1 and 415-2 represent dimension values identified from another dimension value (node 415) that is also an entity. The dimension value scoring service 220 may then assign score adjustment values less than 1 because these dimension values are not directly associated with the model entities.

In another example, the dimension value scoring service 220 may assign lower scores to dimension values identified as being similar to an already identified dimension value. For example, nodes 411-1 through 411-3 represent dimension values that are similar to the already identified dimension value principal software engineer (node 411). The dimension value scoring service 220 may then adjust score values to lower score values to each of the nodes that were identified as being similar values.

In an embodiment, the dimension value scoring service 220 may be configured to assign score values based upon which identification round a dimension value was identified by the dimension value identification service 210. For example, if the dimension value identification service 210 performs n-rounds of dimension value identification, then for each subsequent round, the dimension value scoring service 220 may reduce the overall scoring value assigned to new dimension values. For example, during the first round of identification, dimension values may be assigned an initial score of 1, then during the second round of identification, new dimension values may be assigned an initial score of 0.5, and so on. Scoring values based on when each dimension value is identified may be combined with described scoring algorithms to determine a final score value for each dimension value.

Upon assigning score values to each of the dimension values, the dimension value selection service 225 may identify a set of dimension values for recommendation to a content provider based upon the calculated score values of the identified dimension values. FIG. 4B depicts an example of representative entities and their associated dimensions and dimension values with assigned score values. For example, nodes 412 and 422 may have an assigned score of 2 largely based upon the dimension value “San Francisco” being associated with entity nodes 410 and 420. In contrast, node 421 (Intern software engineer) may have an assigned score of 1 because it is only associated with entity node 420. Examples scores depicted in FIG. 4B may represent simplified scores for the purpose of illustrating selection of dimension values.

In an embodiment, the dimension value selection service 225 may identify dimension values for recommendation based on score values that are above a configured threshold. For example, dimension values that have a calculated score equal to or above 2 may be selected to make up the set of dimension values to recommend to the content provider. Referring to FIG. 4B, the dimension value selection service 225 may identify nodes 412/422, 413/423, 414/424, 432/415-1/425-1, and 433/415-2/425-2 as dimension values that have a score equal to or above the score value threshold of 2. Some nodes, such as nodes 432, 415-1, 425-1, may represent the same dimension value. In an embodiment, the dimension value selection service 225 may be configured to consolidate nodes that refer to the same dimension value into a single dimension value that is only counted once. In another embodiment, the dimension value identification service 210 may consolidate duplicate dimension values to be represented as a single node (not displayed in FIGS. 4A and 4B), such that when the dimension value identification service 210 selects dimension values for selection only unique nodes are selected. In an embodiment, the configured threshold for score values may be established using historical data related to content delivery campaign performance and/or whether a content provider adjusts the number of dimension values selected during content delivery campaign creation.

In an embodiment, the dimension value selection service 225 may limit the number of dimension values selected for recommendation based on a total number of dimension values. Presenting a large number of dimension values to a content provider may confuse or overwhelm content provider administrators, thereby diminishing the purpose of recommending a set of dimension values over recommending all identified dimension values. Additionally, if Boolean logic for matching the dimension values is set to AND, such that matching entities would have to match each dimension value, then recommending too many dimension values may reduce the overall audience size for the new content delivery campaign, as the potential audience of users that satisfy each of the dimension values may be too small. In an embodiment, the dimension value selection service 225 may determine the total audience size for a set of dimension values. If the total audience size is below a desired audience size threshold, then the dimension value selection service 225 may reduce the total number of dimension values within the set of dimension values, such as by removing one or more dimensions and their dimension values, in order to have a total audience size above the desired audience size threshold. In an embodiment, the desired audience size threshold may be calculated using historical content delivery campaign performance data that is either specific to: the content provider, content delivery campaigns within a specific industry, across all content delivery campaigns, or based on provided audience size threshold by the content provider. For example, if the content provider requests an audience size of 300,000 users, then the dimension value selection service 225 may limit the total number of dimension values in order to maintain an audience size above the desired 300,000 user threshold.

In an embodiment, the dimension value selection service 225 may tailor the set of dimension values for recommendation based upon the number of dimensions presented and the number of dimension values within each dimension. For example, the dimension value selection service 225 may be configured to limit the number of dimensions to the top 3 scoring dimensions. In another example, the dimension value selection service 225 may limit the number of dimension values per dimension to the top 3 scoring dimension values. In another embodiment, the dimension value selection service 225 may be configured to limit the set of dimension values based on a combination of the total audience size, the total number of dimensions, and the number of dimension values per dimension.

Referring to FIG. 3, at operation 320 process 300 may cause the set of dimension values to be presented to the content provider. In an embodiment, the dimension value recommendation service 205 may send the set of dimension values to the content delivery system 120 for presentation to the content provider. The content delivery system 120 may present the set of dimension values to the content provider within a graphical user interface that displays the dimension values organized by each dimension. For instance, dimension values associated with the dimension job title may be grouped together for presentation. In an embodiment, the content delivery system 120 may also present other dimension values not selected for recommendation within the graphical user interface, where the other dimension values are tagged as not selected but may be selectable by the content provider. For example, each of the dimension values within the set of recommended dimension values may be highlighted or have an associated check mark to denote that the dimension value is recommended, while the other dimension values are left unchecked. In an embodiment, the graphical user interface may be configured to display the potential audience size based upon the recommended set of dimension values.

### Adjusting the Set of Dimension Values

In an embodiment, the content provider may modify the set of dimension values recommended for the new content delivery campaign by selecting previously unselected dimension values or by deselecting dimension values already within the set of recommended dimension values. For example, the content delivery system 120 may present the set of recommended dimension values to the content provider. The content provider may then provide input to remove one or more dimension values presented within the set of recommended dimension values. The content delivery system 120 may then send the input to remove the one or more dimension values to the dimension value recommendation service 205. The dimension value selection service 225 may then remove the one or more specified dimension values from the set recommended of dimension values. The dimension value selection service 225 may recalculate the audience size based on the remaining dimension values in the set of recommended dimension values. The dimension value recommendation service 205 may then send the updated set of recommended dimension values to the content delivery system 120 for presentation to the content provider with the updated audience size.

If the content provider selected additional dimension values to be included in the set of recommended dimension values, then content delivery system 120 may send the input to add the one or more dimension values to the dimension value recommendation service 205. The dimension value selection service 225 may then add to the set of recommended dimension values, the one or more specified dimension values. The dimension value selection service 225 may recalculate the audience size based on the updated set of recommended dimension values. The dimension value recommendation service 205 may then send the updated set of recommended dimension values to the content delivery system 120 for presentation to the content provider with the updated audience size.

If the content provider approves of the set of recommended dimension values, then the content delivery system 120 may generate the content delivery campaign based upon the set of recommended dimension values.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

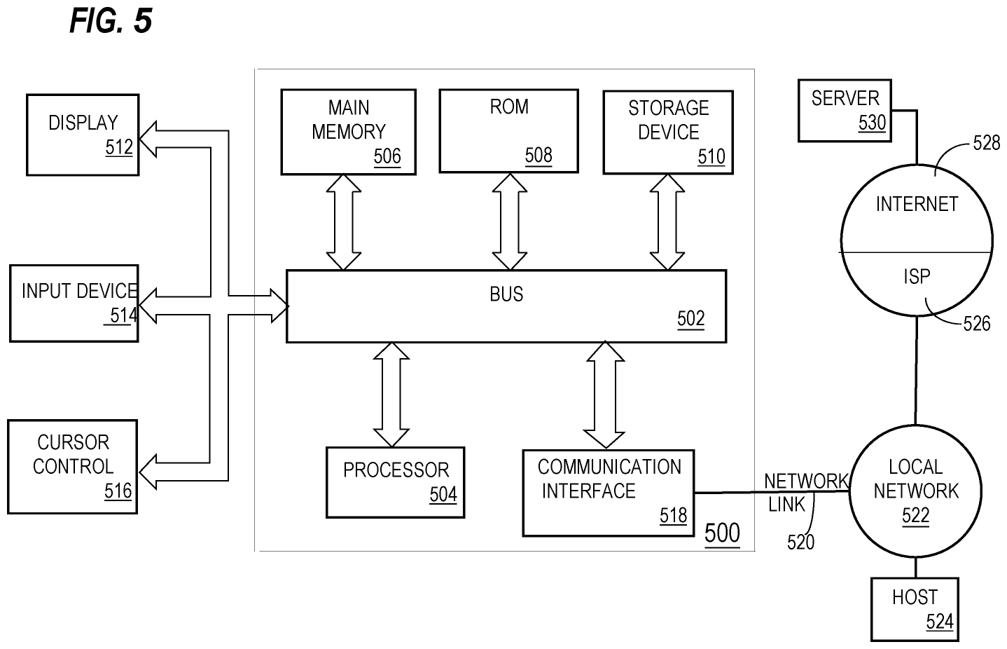

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, from a content provider, input that selects one or more entities;
in response to receiving the input, for each entity of the one or more entities, identifying a plurality of dimension values of said each entity;
based on the plurality of dimension values, determining a set of dimension values to recommend to the content provider; and
causing the set of dimension values to be presented to the content provider;
wherein the method is performed by one or more computing devices.

2. The method of claim 1, wherein the set of dimension values include one or more first dimension values for a first dimension and one or more second dimension values for a second dimension that is different than the first dimension.

3. The method of claim 1, wherein the one or more entities represent at least one of a person or a company.

4. The method of claim 1, further comprising:
determining a subset of dimension values from the plurality of dimension values that are entities;
for each dimension value of the subset of dimension values, identifying a second plurality of dimension values of said each dimension value; and
adding the second plurality of dimension values to the plurality of dimension values.

5. The method of claim 1, wherein determining the set of dimension values to recommend to the content provider comprises:
for each unique dimension value of the plurality of dimension values, calculating a dimension value score based upon a probability of relevance of the unique dimension value to the content provider; and
determining the set of dimension values to recommend to the content provider based on dimension value scores that are above a dimension value score threshold used to determine dimension values that qualify for recommendation.

6. The method of claim 5, wherein the dimension value score is based upon a number of entities of the one or more entities that have the unique dimension value.

7. The Method of claim 5, wherein determining the set of dimension values to recommend to the content provider comprises:
identifying dimension values to recommend based on the dimension value scores that are above a dimension value score threshold; and
generating the set of dimension values for recommendation, wherein a number of dimension values in the set of dimension values are below a threshold number of total dimension values, and wherein the set of dimension values comprise dimension values with the highest dimension value scores.

8. The method of claim 1, further comprising:
receiving, from the content provider, second input to modify the set of dimension values presented to the content provider;
modifying the set of dimension values based upon the second input received from the content provider; and
presenting a modified set of dimension values to the content provider.

9. The method of claim 1, further comprising:
receiving, from the content provider, second input specifying a content delivery campaign generated from the set of dimension values presented to the content provider;
tracking performance metrics associated with each dimension value of the set of dimension values from the content delivery campaign; and
providing the performance metrics to a dimension value scoring service as feedback for scoring dimension values associated with future content delivery campaigns.

10. A system comprising:
one or more computer processors;
a content delivery system coupled to the one or more processors, wherein the content delivery system performs operations comprising:
receiving, from a content provider, input that selects one or more entities;
in response to receiving the input, for each entity of the one or more entities, identifying a plurality of dimension values of said each entity;
based on the plurality of dimension values, determining a set of dimension values to recommend to the content provider; and
causing the set of dimension values to be presented to the content provider.

11. The system of claim 10, wherein the set of dimension values include one or more first dimension values for a first dimension and one or more second dimension values for a second dimension that is different than the first dimension.

12. The system of claim 10, wherein the one or more entities represent at least one of a person or a company.

13. The system of claim 10, wherein the content delivery system performs further operations comprising:
determining a subset of dimension values from the plurality of dimension values that are entities;
for each dimension value of the subset of dimension values, identifying a second plurality of dimension values of said each dimension value; and
adding the second plurality of dimension values to the plurality of dimension values.

14. The system of claim 10, wherein determining the set of dimension values to recommend to the content provider comprises:
for each unique dimension value of the plurality of dimension values, calculating a dimension value score based upon a probability of relevance of the unique dimension value to the content provider; and
determining the set of dimension values to recommend to the content provider based on dimension value scores that are above a dimension value score threshold used to determine dimension values that qualify for recommendation.

15. The system of claim 14, wherein the dimension value score is based upon a number of entities of the one or more entities that have the unique dimension value.

16. The system of claim 14, wherein determining the set of dimension values to recommend to the content provider comprises:
identifying dimension values to recommend based on the dimension value scores that are above a dimension value score threshold; and
generating the set of dimension values for recommendation, wherein a number of dimension values in the set of dimension values are below a threshold number of total dimension values, and wherein the set of dimension values comprise dimension values with the highest dimension value scores.

17. The system of claim 10, wherein the content delivery system performs further operations comprising:
receiving, from the content provider, second input to modify the set of dimension values presented to the content provider;
modifying the set of dimension values based upon the second input received from the content provider; and
presenting a modified set of dimension values to the content provider.

18. The system of claim 10, wherein the content delivery system performs further operations comprising:
receiving, from the content provider, second input specifying a content delivery campaign generated from the set of dimension values presented to the content provider;
tracking performance metrics associated with each dimension value of the set of dimension values from the content delivery campaign; and
providing the performance metrics to a dimension value scoring service as feedback for scoring dimension values associated with future content delivery campaigns.

19. A computer program product comprising:
one or more non-transitory computer-readable storage media comprising instructions which, when executed by one or more processors, cause:
receiving, from a content provider, input that selects one or more entities;
in response to receiving the input, for each entity of the one or more entities, identifying a plurality of dimension values of said each entity;
based on the plurality of dimension values, determining a set of dimension values to recommend to the content provider; and
causing the set of dimension values to be presented to the content provider.

20. The computer program product of claim 19, wherein determining the set of dimension values to recommend to the content provider comprises:
for each unique dimension value of the plurality of dimension values, calculating a dimension value score based upon a probability of relevance of the unique dimension value to the content provider; and
determining the set of dimension values to recommend to the content provider based on dimension value scores that are above a dimension value score threshold used to determine dimension values that qualify for recommendation.
